(19) United States
(12) Patent Application Publication
(10) Pub. No.: US 2023/0359626 A1
(43) Pub. Date: Nov. 9, 2023

(54) METHOD AND APPARATUS FOR PROCESSING APPROXIMATE QUERY BASED ON MACHINE LEARNING MODEL

(71) Applicant: Electronics and Telecommunications Research Institute, Daejeon (KR)

(72) Inventors: Choon Seo PARK, Daejeon (KR); Tae Whi LEE, Daejeon (KR); Sung Soo KIM, Daejeon (KR); Taek Yong NAM, Daejeon (KR)

(73) Assignee: Electronics and Telecommunications Research Institute, Daejeon (KR)

(21) Appl. No.: 18/307,509

(22) Filed: Apr. 26, 2023

(30) Foreign Application Priority Data
May 4, 2022 (KR) 10-2022-0055602

(51) Int. Cl. G06F 16/2455; G06N 20/00

(52) U.S. Cl. CPC G06F 16/2455; G06N 20/00

(57) ABSTRACT

Provided are a method and apparatus for processing an approximate query based on a machine learning model. When receiving a user query through an approximate query language extension interface, a processing apparatus parses a user query. The user query is an extended query form that includes information according to a user requirements. The processing apparatus generates a basic execution plan based on a parsing result and generates a plurality of executable candidate execution plans based on the basic execution plan. Then, an optimal final execution plan reflecting user requirements is selected from among the plurality of executable candidate execution plans, and query processing is performed on the user query based on a final execution plan.

### CROSS-REFERENCE TO RELATED APPLICATION

This application claims priority to and the benefit of Korean Patent Application No. 10-2022-0055602 filed in the Korean Intellectual Property Office on May 4, 2022, the entire contents of which are incorporated herein by reference.

### 1. Field of the Invention

The present disclosure relates to a query processing method, and more particularly, to a method and apparatus for processing an approximate query based on a machine learning model.

### 2. Discussion of Related Art

As the amount of data rapidly increases and becomes more complex in the recent big data environment, when query processing is performed by accessing raw data during performing data query processing, high query processing costs are incurred, resulting in making it difficult for a user to quickly obtain desired results.

In order to solve this problem, the need for research on a method of processing an approximate query, which may quickly obtain results by reducing the time required to perform query processing even if the accuracy of the results is somewhat low, is increasing. The method of processing an approximate query is one of the useful techniques which can provide approximate query results in a short time using only a portion of resources required to execute an exact query.

In performing the approximate query processing, the user's desired accuracy and timeliness needs to be delivered well to a query processing engine. In the case of the existing query languages, there is a disadvantage in that the existing query languages do not have sufficient means of expressing these requirements.

In addition, there is a need to generate and perform an optimal execution plan for an approximate query according to the requirements.

The above information disclosed in this background section is only for enhancement of understanding of the background of the invention, and therefore it may contain information that does not form the prior art that is already known in this country to a person of ordinary skill in the art.

### SUMMARY OF THE INVENTION

The present disclosure provides a method and apparatus for processing an approximate query by extending and supporting a query language which can express requirements such as user's desired query accuracy and query processing time during approximate query processing.

In addition, the present disclosure provides a method and apparatus for processing an approximate query by estimating execution costs of each of a plurality of execution plans and selecting an optimal execution plan while satisfying user's desired requirements.

According to an embodiment of the present disclosure, a method of processing an approximate query is provided. The method of processing an approximate query includes: parsing, by a processing device, a user query when the user query is input through an approximate query language extension interface, the user query being an extended query form including information according to a user requirement; generating, by the processing device, a basic execution plan based on a result of the parsing, and generating a plurality of executable candidate execution plans based on the basic execution plan; selecting, by the processing device, an optimal final execution plan reflecting the user requirement from among the plurality of executable candidate execution plans; and performing, by the processing device, query processing on the user query based on the final execution plan.

The approximate query language extension interface may provide a query grammar extension function that allows a user to select desired accuracy and timeliness.

The user requirement may include information on an error tolerance range corresponding to the accuracy and information on a query processing allowable time corresponding to the timeliness.

The approximate query language extension interface may provide a query grammar extension function based on a structured query language (SQL) grammar.

The selecting of the final execution plan may include: selecting a candidate execution plan that satisfies the user requirement from among the plurality of executable candidate execution plans; and when there is a plurality of selected candidate execution plans, calculating query processing costs for each candidate execution plan and selecting a candidate execution plan having a minimum query processing cost as the final execution plan.

In the generating of the plurality of executable candidate execution plans, a plurality of candidate execution plans may be generated using a result inference type model and a synopsis generation type model.

The generating of the plurality of executable candidate execution plans may include: inferring a prediction result through a first machine learning model that infers a query prediction result and generating a first candidate execution plan based on the inferred prediction result; generating a synopsis of the query through a second machine learning model that generates a synopsis, which is synthesized data usable for query processing, from raw data to generate a second candidate execution plan; and reusing a previously generated synopsis to generate a third candidate execution plan.

The performing of the query processing may include: accessing raw data to perform the query processing according to the final execution plan, when it is determined that the user query is an exact query based on a parsing result.

The performing of the query processing may include: accessing synopsis data, which is synthesized data acquired from the raw data to perform the query processing according to the optimal execution plan and performing query processing according to the optimal execution plan, when it is determined that the user query is an approximate query based on the parsing result.

The performing of the query processing may include: performing an operation of accessing prediction result generated by inferring a prediction result of the query and performing query processing according to the optimal execution plan, when it is determined that the user query is an approximate query based on the parsing result.

The accessing of the synopsis data to perform the query processing according to the optimal execution plan may include: generating synopsis data based on a machine learning model and performing the query processing using the generated synopsis data; and performing the query processing using pre-generated synopsis data according to a syntax in a previous query form.

According to an embodiment of the present disclosure, an apparatus for processing an approximate query is provided. The apparatus for processing an approximate query includes: an interface device configured to provide an approximate query language extension interface; and a processor configured to perform query processing according to a user query input through the approximate query language extension interface, the user query being in a form of an extended query including information according to user requirement, in which the processor includes: a query parser configured to parse the user query; a query transformer configured to generate a basic execution plan based on the parsing result and generate a plurality of executable candidate execution plans based on the basic execution plan; a query optimizer configured to select an optimal final execution plan reflecting the user requirement from among the plurality of executable candidate execution plans; and a query executor configured to perform the query processing on the user query based on the final execution plan.

The approximate query language extension interface may provide a query grammar extension function that allows a user to select desired accuracy and timeliness.

The user requirement may include information on an error tolerance range corresponding to the accuracy and information on a query processing allowable time corresponding to the timeliness.

The query optimizer may be configured to select a candidate execution plan that satisfies the user requirement from among the plurality of executable candidate execution plans, and calculate query processing costs for each candidate execution plan and select a candidate execution plan having a minimum query processing cost as a final execution plan when the number of selected candidate execution plans is plural.

The query transformer may be configured to generate a plurality of candidate execution plans using a result inference type model and a synopsis generation type model.

The query transformer may be configured to perform: an operation of inferring a prediction result through a first machine learning model that infers a query prediction result and generating a first candidate execution plan based on the inferred prediction result; an operation of generating a synopsis of the query through a second machine learning model that generates a synopsis, which is synthesized data usable for query processing, from raw data to generate a second candidate execution plan; and an operation of reusing a previously generated synopsis to generate a third candidate execution plan.

The query executor may be configured to perform: an operation of accessing raw data to perform the query processing according to the final execution plan, when it is determined that the user query is an exact query based on the parsing result.

The query executor may be configured to perform: an operation of accessing synopsis data, which is synthesized data acquired from the raw data to perform the query processing according to the optimal execution plan and perform query processing according to the optimal execution plan, when it is determined that the user query is an approximate query based on the parsing result.

The query executor may be configured to perform: an operation of accessing prediction result generated by inferring a prediction result of the query and performing query processing according to the optimal execution plan, when it is determined that the user query is an approximate query based on the parsing result.

In the case of the operation of accessing the synopsis data to perform the query processing according to the optimal execution plan, the query executor may be configured to perform: an operation of generating synopsis data based on a machine learning model and performing the query processing using the generated synopsis data; and an operation of performing the query processing using pre-generated synopsis data according to a syntax in a previous query form.

The apparatus may further include a metadata storage unit configured to store and manage table and column information of raw data for accessing the raw data, an ML model, and a model instance.

### BRIEF DESCRIPTION OF THE DRAWINGS

FIG. 1 is a diagram illustrating a structure of an apparatus for processing an approximate query according to an embodiment of the present disclosure.

FIG. 2 is a conceptual diagram illustrating a process of processing an approximate query according to an embodiment of the present disclosure.

FIG. 3 is a diagram illustrating a process of processing a query while an approximate query language extension is performed based on an apparatus for processing an approximate query according to an embodiment of the present disclosure.

FIG. 4 is a diagram illustrating an example of using an approximate query language extension according to an embodiment of the present disclosure.

FIG. 5 is a diagram illustrating a process of generating and optimizing a query execution plan according to an embodiment of the present disclosure.

FIG. 6 is an exemplary diagram illustrating a process of performing query processing according to an embodiment of the present disclosure.

FIG. 7 is a flowchart of a method of processing an approximate query according to an embodiment of the present disclosure.

FIG. 8 is a structural diagram for describing a computing device for implementing the method according to the embodiment of the present disclosure.

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the accompanying drawings and description are to be regarded as illustrative in nature and not restrictive. Like reference numerals designate like elements throughout the specification.

Throughout this specification and the claims that follow, when it is described that an element is “coupled” or “connected” to another element, the element may be “directly coupled” or “directly connected” to the other element, or “electrically coupled” or “electrically connected” to the other element through a third element. In addition, unless explicitly described to the contrary, the word “comprise” or “include,” and variations such as “comprises,” “comprising,” “includes,” or “including” will be understood to imply the inclusion of stated elements but not the exclusion of any other elements.

In the present disclosure, an expression written in singular may be construed in singular or plural unless an explicit expression such as “one” or “single” is used.

In addition, terms such as first, second, A, and B used in the embodiments of the present disclosure may be used to describe components, but components should not be limited by the terms. Terms are used only in order to distinguish one component from another component. For example, the ‘first’ component may be named the ‘second’ component, and vice versa, without departing from the scope of the present disclosure.

Hereinafter, a method and apparatus for processing an approximate query based on a machine learning model according to embodiments of the present disclosure will be described with reference to the accompanying drawings.

As the method of processing an approximate query, there are a method of processing an approximate query based on a summary technique and a method of processing an approximate query based on a machine learning (ML) model.

The method of processing an approximate query based on the summary technique performs approximate query processing based on the summary technique using sampling, histogram, wavelet, etc. The approximate query based on the summary method does not query the entire data, which is raw data, but performs query processing on summarized data information after performing a data reduction process such as sampling some data from raw data. Accordingly, by reducing a data size for the query processing, it is possible to quickly obtain results with less computational cost.

The method of processing an approximate query based on an ML model uses the ML model generated based on raw data to process an approximate query without direct access to raw data. Various researches such as an approximate query method of a query-driven model that generate an ML model by training data with pre-executed exact queries, and a data-driven model that trains an ML model from data has been conducted recently.

In such ML model-based approximate query processing, the user's desired accuracy and timeliness should be delivered well to the query processing engine. Since the existing query language lacks means to express these requirements, the existing query language needs to be extended and provided. In an embodiment of the present disclosure, in order for users familiar with the existing structured query (SQL) grammar to easily understand and utilize, a query language is extended and provided so that a method of expressing accuracy and timeliness is similar to the existing SQL expression method.

Meanwhile, a query parser function should be performed on the approximate query language sentence that is extended and provided, and an execution plan for the approximate query should be generated. There is a need to select the most optimal execution plan among several generated execution plans, execute the corresponding execution plan, and provide a function of delivering approximate query results to a user. In this case, it is most important to select the optimal execution plan that may show the best performance while satisfying the user's desired accuracy and timeliness among various execution plans.

In an embodiment of the present disclosure, for an approximate query language extension for supporting approximate query processing, execution plan generation and optimization, a method and apparatus for performing approximate query processing based on an ML model are provided.

To this end, the approximate query is performed through the query language extension support and approximate query analysis for expressing the user's desired requirements (error tolerance range, query processing allowable time, etc.), the execution plan generation, and the approximate query optimization for selecting the optimal execution plan that may most efficiently reduce query processing costs.

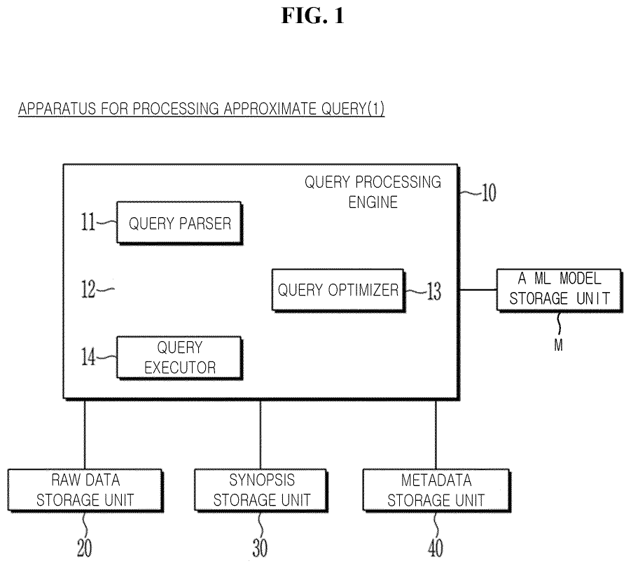

FIG. 1 is a diagram illustrating a structure of an apparatus for processing an approximate query according to an embodiment of the present disclosure.

As illustrated in FIG. 1 attached, an apparatus for processing an approximate query 1 according to the embodiment of the present disclosure includes a query processing engine 10, a raw data storage unit 20, a synopsis storage unit 30, a metadata storage unit 40 and a ML model storage unit M.

The query processing engine 10 includes a query parser 11, a query transformer 12, a query optimizer 13, and a query executor 14. The query processing engine 10 performs query processing in association with a raw data storage unit 20, a synopsis storage unit 30, a metadata storage unit 40, and a ML model storage unit M utilizes an ML model when processing an approximate query, and may include a synopsis generation model and a result inference model.

The query parser 11 is configured to parse a query sentence corresponding to an input user query. In particular, the query parser 11 parses an input query sentence and determines whether the parsed query sentence is an exact query sentence or an approximate query sentence. The exact query corresponds to an existing exact query requesting an exact query result. The approximate query sentence is an approximate query in which the user's desired requirements may be expressed as options. Here, the requirements may include accuracy, error tolerance range, query processing allowable time, etc.

The query transformer 12 is configured to generate multiple execution plans after transforming the query sentence based on the parsing result of the query sentence. In an embodiment of the present disclosure, in generating the execution plan, a synopsis generation type model (data-driven model) and a result inference model (query-driven model) may be used as a method of utilizing an ML model.

The query optimizer 13 is configured to select a final execution plan by performing an optimization process on a plurality of generated execution plans. In particular, the query optimizer 13 is configured to select the final execution plan that satisfies the user requirements while having the most efficient query processing costs.

The query executor 14 is configured to perform the query processing according to the selected final execution plan. In particular, when the user query is an exact query, the query processing is performed by accessing the raw data of the raw data storage unit 20, and when the user query is an approximate query, the approximate query processing is performed by accessing the synopsis data or the ML model of the synopsis storage unit 30.

The raw data storage unit 20 stores and manages raw data collected in a big data environment. The raw data storage unit 20 may be a raw database management system (DBMS).

The synopsis storage unit 30 is configured to store and manage synopsis (also referred to as synopsis data), which is synthesized data usable for query processing. The synopsis storage unit 30 may store synopsis data previously generated from raw data or synopsis data generated from raw data based on an ML model for an input user query.

The metadata storage unit 40 is configured to store and manage metadata such as table and column information of raw data for accessing the raw data, and store and manage metadata related to ML models and model instances. The metadata storage unit 40 may also be referred to as a data catalog store.

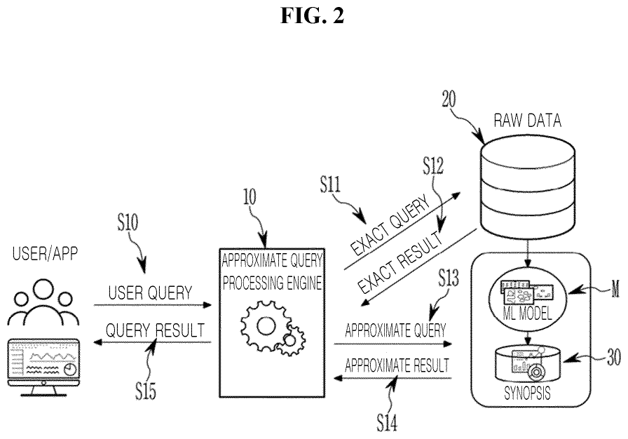

FIG. 2 is a conceptual diagram illustrating a process of processing an approximate query according to an embodiment of the present disclosure.

As illustrated in FIG. 2 attached, when a user or an application program requests processing while delivering the user query for performing query processing (S10), the query processing engine 10 parses the input user query to perform an operation of determining whether the parsed user query is an exact query or an approximate query. When the query corresponding to the user query is the exact query (S11), the query processing engine 10 accesses raw data, which is the entire data of the raw data storage unit 20, and performs the query to acquire an exact query result (exact result) (S12). On the other hand, when the query sentence corresponding to the user query is the approximate query (S13), the query processing engine 10 accesses the synopsis data generated through the ML model M or the synopsis data stored in the synopsis storage unit 30 to perform the approximate query processing, thereby acquiring the approximate query result (approximate result) (S14).

In addition, the query processing engine 10 performs approximate query processing by predicting a result using a result inferential ML model of the ML model storage unit (M in FIG. 2) (S14).

The query processing engine 10 collects query results and delivers a final query result to a user who requests a query (S15).

Based on this concept, detailed operations and methods performed by the apparatus for processing an approximate query according to the embodiment of the present disclosure will be described.

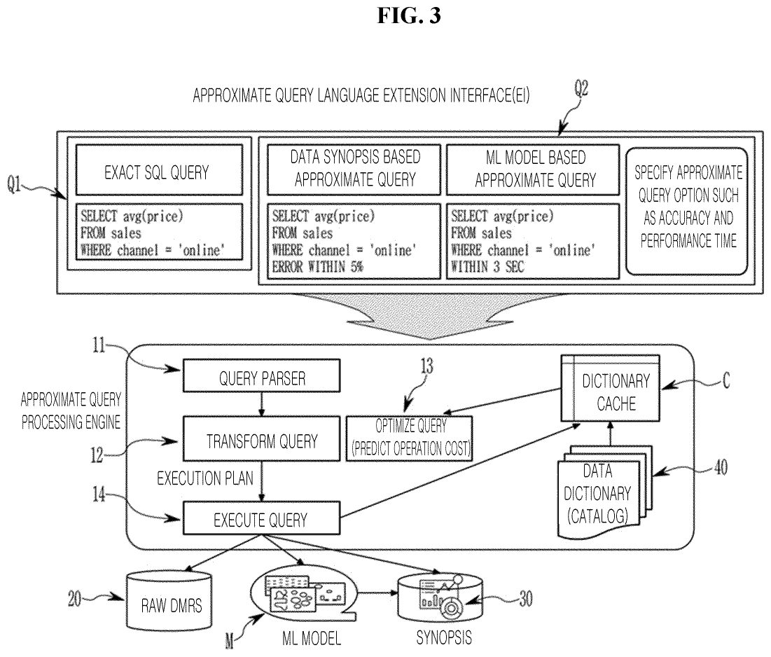

FIG. 3 is a diagram illustrating a process of processing a query while an approximate query language extension is performed based on an apparatus for processing an approximate query according to an embodiment of the present disclosure.

As illustrated in FIG. 3, the form of the user query input to the apparatus 1 for processing an approximate query is divided into an exact query sentence Q1 and an approximate query sentence Q2. The user may query by selecting a query type. To this end, the apparatus 1 for processing an approximate query provides an approximate query language extension interface EI.

The approximate query language extension interface EI provides a query grammar extension function that supports processing the approximate query by extending the existing exact query to express user requirements as options. By extending the query syntax similar to the SQL grammar, a method of extending a query grammar enables existing SQL users to easily understand, extend, and utilize the query grammar.

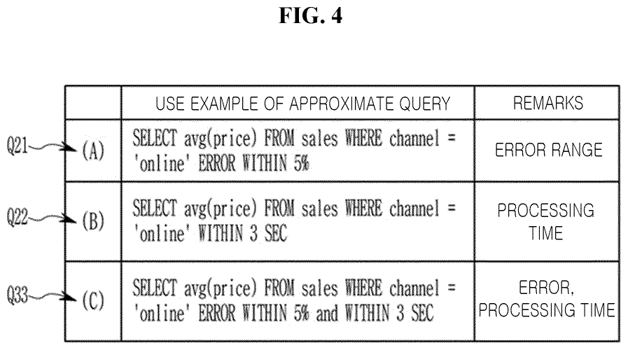

FIG. 4 is a diagram illustrating an example of using an approximate query language extension according to an embodiment of the present disclosure.

As illustrated in FIG. 4 attached, the approximate query sentence may be expressed as a language extension to indicate an error tolerance range (e.g., error within 5%) of the approximate query result, like the query language sentence A (Q21). In addition, the query processing allowable time (e.g., within 3 sec) of the user's desired query result may be expressed as in a query language sentence B (Q22). Also, like the query language sentence C (Q23), both the error tolerance range and the query processing allowable time may be expressed simultaneously (e.g., error within 5% and within 3 sec). In this way, the query language extension is supported so that the user may individually request the accuracy (error tolerance range) and timeliness (query processing allowable time) of the user's desired approximate query, or request both the user's desired accuracy and timeliness at once. Therefore, the user requirements may be configured in several combinations, and the user requirements may be further extended in addition to the accuracy and timeliness, if necessary.

Meanwhile, as illustrated in FIG. 3, the query parser 11 of the apparatus 1 for processing an approximate query parses the user query provided through the approximate query language extension interface EI as described above, and determines whether a query sentence corresponding to a user query is an exact query sentence or an approximate query sentence based on the analysis result.

The query transformer 12 generates a basic execution plan for query processing based on the parsing result, and generates a plurality of executable candidate execution plans based on the generated basic execution plan. Here, the plurality of candidate execution plans may be generated using the ML model, and for example, a plurality of candidate execution plans may be generated using a result inference type model or a synopsis generation type model. A method of generating a plurality of candidate execution plans will be described in more detail below.

The query optimizer 13 is configured to utilize and select an optimal execution plan from a plurality of candidate execution plans. In particular, the optimal execution plan that may minimize the query processing costs while satisfying the user requirements (error tolerance range and query processing allowable time) is finally selected. The optimization process for selecting the optimal execution plan will be described in more detail below.

Meanwhile, the query executor 14 is configured to perform query processing based on an execution plan (referred to as a final execution plan) finally selected by the query optimizer 13. To this end, the query executor 14 accesses the raw data of the raw data storage unit 20 or the synopsis data of the synopsis storage unit 30 or ML model storage unit (M in FIG. 2) to perform the query processing, thereby acquiring the corresponding result. Specifically, when the user query is the exact query, the query executor 14 performs a query processing process of acquiring an exact query result by accessing raw data. On the other hand, when the user query is the approximate query, the query executor 14 performs the approximate query processing by accessing the ML model M or the synopsis data instead of accessing the raw data, an approximate query result value is obtained. In this case, without accessing the raw data, metadata related to ML models and model instances for query processing such as ML models, model instances, and table and column information of raw data are used to process a query stored and managed in the metadata storage unit 40. Such metadata may be information of the most recently used data dictionary, such as a table, a column, a user name, and use authority. In the parsing step, the query processing engine may search for an object name specified in the SQL sentence and search for information in a dictionary cache to verify access authority, and may also use the dictionary cache when generating a new execution plan.

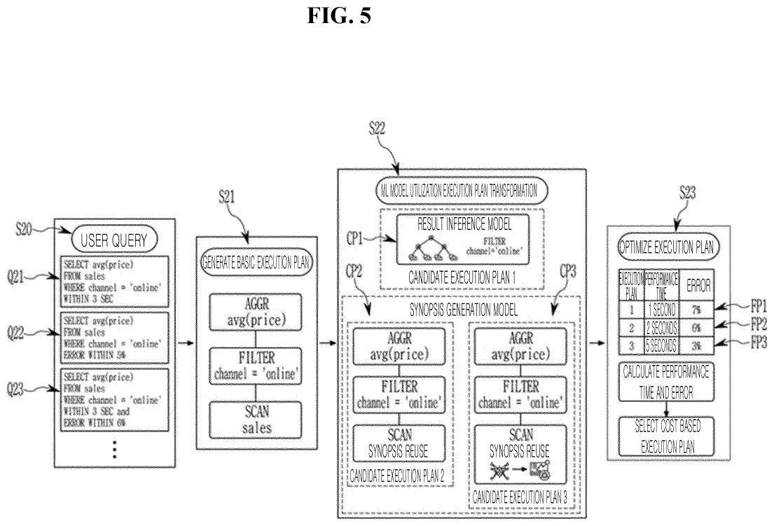

FIG. 5 is a diagram illustrating a process of generating and optimizing a query execution plan according to an embodiment of the present disclosure.

An optimization method of selecting an optimal execution plan predicts the query execution time and result error for each execution plan in consideration of the user's desired accuracy and timeliness, etc., and is most likely to satisfy all the user's desired requirements, and among these requirements, the optimization method preferentially selects the most cost-effective execution plan because the query processing cost (also referred to as query processing operation cost) is relatively low. To this end, various types of meta data information required in the approximate query processing process is stored and managed in a catalog store (metadata storage unit) which is a separate location.

As illustrated in FIG. 5 attached, when the user query are input in various forms (S20), parsing is performed on user query sentences Q21, Q22, and Q23, and a basic execution plan BP including a plurality of operators is performed based on the parsing results (S21). The plurality of executable candidate execution plans CP1, CP2, and CP3 are generated using the ML model based on the generated basic execution plan.

In the embodiment of the present disclosure, the method of utilizing an ML model may be divided into a result inference type model method and a synopsis generation type model method. The result inference model method generates an ML model (for convenience of explanation, referred to as a first ML model) that infers a predicted result of a user's specific type of query, and constructs an execution plan for executing a query for the corresponding query based on the predicted result inferred through the first ML model. Since these ML models are generated and trained from the exact query sentences and results performed in advance, these ML models are optimized for the trained query form, but when the query form is changed, a new ML model needs to be generated or updated.

The synopsis generation type model method does not perform the query on the entire data, but generates an ML model (for convenience of description, a second ML model) that generates a synopsis, which is synthesized data that may be used for the query processing, and generates a synopsis for the query through the generated second ML model. The synopsis may be generated to have the same form as the raw data but have the generated values, or may be generated to have another form that supports operator processing. Since the synopsis generation type model method is to reduce query execution time by reducing a size of query target data, it is possible to quickly obtain processing results by reducing the query processing time even if the query accuracy is somewhat lower.

Based on this, as illustrated in FIG. 5 attached, as an implementation example, after the basic execution plan (BP) is generated, the result inference type model method utilizes the first ML model to generate candidate execution plan 1 CP1 from the basic execution plan, the synopsis generation type model method reuses a previously generated synopsis to generate candidate execution plan 2 CP2, and the synopsis generation type model method utilizes the second ML model to generate a new synopsis and generate candidate execution plan 3 CP3 (S22).

In this way, after generating the plurality of executable candidate execution plans (candidate execution plan 1, candidate execution plan 2, and candidate execution plan 3) based on the basic execution plan, each candidate execution plan predicts results corresponding to user requirements. For example, the error range, the query execution time, etc., are predicted according to the user requirements, and the most optimal execution plan (final execution plan) is selected based on the cost (query processing cost) from the predicted results for each candidate execution plan. For example, priorities are set for each candidate execution plan based on cost, and a candidate execution plan having the highest priority is selected as the final execution plan (S23).

As a more specific example, as illustrated in FIG. 5, when the user requirement in the user query is that the query processing allowable time is within 3 seconds, the candidate execution plan 1 and the candidate execution plan 2, which satisfy the user requirements among the plurality of candidate execution plans, are preferentially selected through the execution plan optimization (S23), and then, the optimal execution plan is selected from among the candidate execution plans 1 and 2. In this case, among the two candidate execution plans that satisfy the user requirements, the candidate execution plan 1 having the shortest predicted query processing execution time is selected as a final execution plan FP1.

Meanwhile, when the requirement in the user query is that an error tolerance range is within 5% or less, the execution plan 3 whose predicted error range satisfies the error tolerance range condition among the plurality of candidate execution plans is selected as a final execution plan FP3.

In addition, when the user requirements in the user query is that the query processing allowable time is within 3 seconds and the error tolerance range is within 6%, the candidate execution plan 2 that satisfies both the user requirements among the candidate execution plans is selected as a final execution plan FP2.

Meanwhile, when there are many candidates satisfying the user requirements, a candidate execution plan having the lowest cost is selected as the final execution plan. Here, when there is no candidate execution plan that satisfies the user requirements, the candidate execution plan closest to the user requirements is selected as the final execution plan from among the candidate execution plans.

As described above, after the final execution plan is selected through the optimization process, the query processing is performed based on the selected final execution plan.

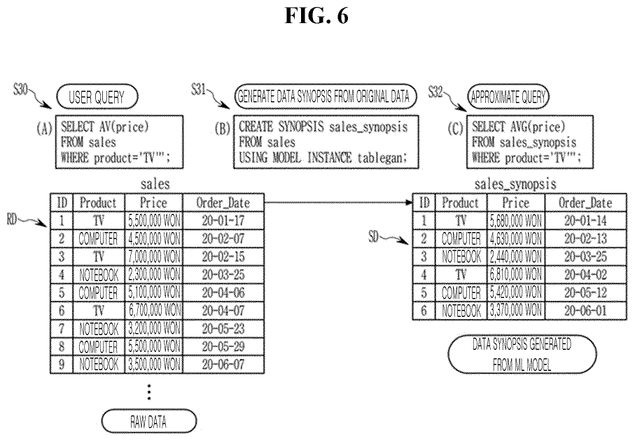

FIG. 6 is an exemplary diagram illustrating a process of performing query processing according to an embodiment of the present disclosure.

As a specific example, as illustrated in FIG. 6, when the corresponding analysis query is processed as an approximate query and a user query is input to process an analysis query request for raw data (S30), synopsis data is generated from original data using a synopsis generation type model (S31). Here, a synopsis may be generated in advance through syntax B of FIG. 6. When there is no previously generated synopsis data, new synopsis data is generated when the query processing is requested.

In this case, the ML model instance utilized to generate the data synopsis needs to be registered and trained in advance through a separate syntax.

When the user query is an exact query, as in the conventional case, the query processing is performed by accessing raw data RD of the raw data storage unit 20. Meanwhile, when the user query is an approximate query, a result may be provided by processing the query using the generated synopsis SD instead of directly accessing the raw data.

Such a synopsis-based query may be processed by a method of processing a query by generating a new synopsis, a method of processing a query by reusing a pre-generated synopsis to reduce production cost, or the like. The synopsis-based query processing is not optimized for a specific query type, but has merely a structure that reduces a data size, and therefore, may be an efficient method even for models whose query form changes frequently.

Based on the process described above, a method of processing an approximate query according to an embodiment of the present disclosure will be described.

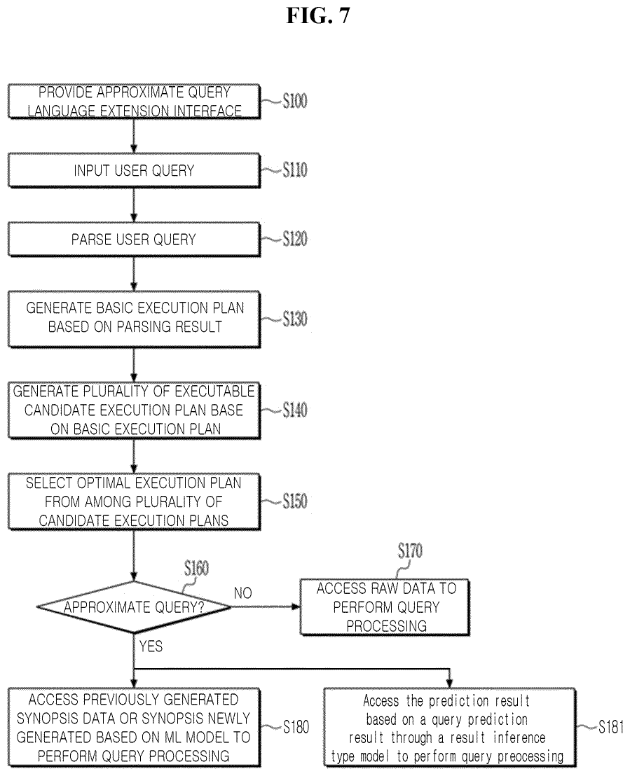

FIG. 7 is a flowchart of a method of processing an approximate query according to an embodiment of the present disclosure.

The apparatus 1 for processing an approximate query according to the embodiment of the present disclosure provides an interface for inputting a user query, and in particular, provides an approximate query language extension interface as illustrated in FIG. 7 (S100). Accordingly, the user query is input in the form of the exact query or the approximate query, and in particular, may be input in the form of the extended approximate query that may express the user requirements as an option.

When a user or an application program inputs a user query for query processing through this interface (S110), the apparatus 1 for processing an approximate query parses the user query and generates a basic execution plan (S120 and S130).

The apparatus 1 for processing an approximate query generates a plurality of executable candidate execution plans based on the basic execution plan (S140).

An optimal execution plan is selected from among the plurality of executable candidate execution plans (S150). When the user query is the approximate query, the optimal execution plan that may minimize the query processing cost while satisfying the user requirements (error tolerance range, query processing allowable time, etc.) is selected from among the plurality of candidate execution plans.

Next, the apparatus 1 for processing an approximate query performs the query processing based on the optimal execution plan. When the user query is an exact query, a query result is acquired by accessing the raw data of the raw data storage unit 2 and performing the query processing according to the optimal execution plan (S160, S170). On the other hand, when the user query is an approximate query, the query result is acquired by accessing the synopsis data of the synopsis storage unit 30 and performing the query processing according to the optimal execution plan. Here, the synopsis data of the synopsis storage unit 30 may be pre-generated synopsis data according to the syntax in the previous query form, or synopsis data newly generated according to a query based on the ML model (S160, S180) or the query result is acquired by performing approximate query processing by predicting a result using a result inferential ML model of the ML model storage unit (S160, S181). Then, query results are provided.

According to this embodiment, while making an approximate query request that may express the user desired requirements as an option, each processing cost is predicted for a plurality of execution plans that may be executed for the user's query request, so the execution plan optimization is performed to select the execution plan with the most efficient query processing cost. In addition, it is possible to increase the approximate query processing speed using the ML model through the optimized execution plan to perform the query processing to access the synopsis data acquired from the raw data or to access the prediction result generated by inferring a prediction result of the query using a result inferential ML model.

In particular, it is possible to reduce the size of the approximate query processing target and reduce the query processing cost using the synopsis data instead of directly accessing and using raw data as a query processing target. Even though the approximate query results are slightly less accurate than the exact query results, it is highly likely to satisfy the requirements for the user's desired query processing speed.

In addition, since the synopsis data generated in advance may be reused, the synopsis data generation costs may be reduced.

According to embodiments, when processing an approximate query in a big data environment, it is possible to select an optimal execution plan that satisfies user requirements and process the query. In particular, by estimating processing costs of each of the plurality of executable execution plans and selecting an execution plan, which is the most efficient in query processing costs and satisfies the user requirements, as an optimal execution plan, it is possible to increase approximate query processing.

In addition, in order to perform approximate query processing, by using a machine learning model to newly generate a synopsis using a summary technique without directly accessing raw data or by reusing the existing synopsis to perform query processing, it is possible to increase approximate query processing while reducing query processing costs. In addition, it is possible to quickly obtain query processing results using the prediction result generated by inferring a prediction result of the query using a result inferential ML model.

The approximate query results thus obtained are somewhat less accurate, but query results are provided in a timely manner, so users may quickly identify trend in data. Therefore, the method and apparatus according to the embodiment of the present disclosure may be usefully used in application fields such as search or visualization where approximate query processing results are allowed rather than exact query results and quick results are required.

In addition, by providing a query language extension interface that may be extended and expressed similarly to an SQL grammar, user requirements may be easily expressed and extended, and the existing SQL grammar users may be easily understand and utilized.

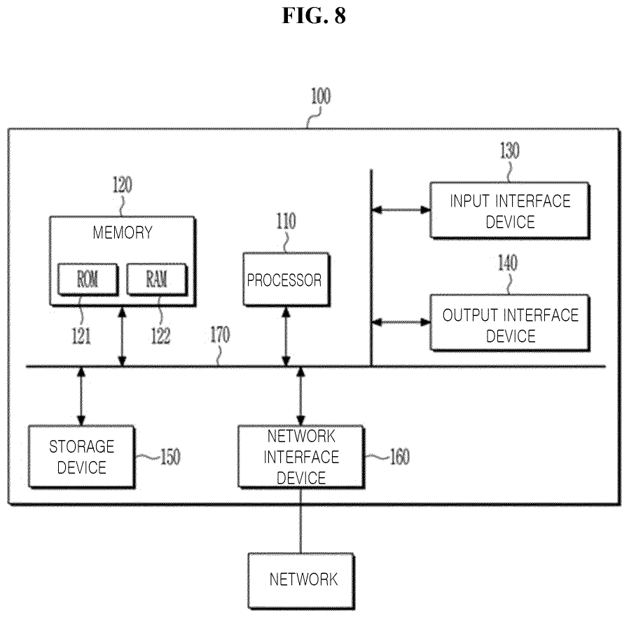

FIG. 8 is a structural diagram for describing a computing device for implementing the method according to the embodiment of the present disclosure.

As illustrated in FIG. 8, a method of processing an approximate query according to an embodiment of the present disclosure may be implemented using a computing device 100.

The computing device 100 may include at least one of a processor 110, a memory 120, an input interface device 130, an output interface device 140, a storage device 150, and a network interface device 160. Each component may be connected through a bus 170 to communicate with each other. In addition, each of the components may be connected through individual interfaces or individual buses centering on the processor 110 instead of a common bus 170.

The processor 110 may be implemented in any of various types such as an application processor (AP), a central processing unit (CPU), a graphics processing unit (GPU), and the like, and may be any semiconductor device that executes commands stored in the memory 120 or the storage device 150. The processor 110 may execute program commands stored in at least one of the memory 120 and the storage device 150. Such a processor 110 may be configured to implement the functions and methods described above based on FIGS. 1 to 7. For example, the processor 110 may be implemented to perform functions of a query parser, a query transformer, a query optimizer, and a query executor.

The memory 120 and the storage device 150 may include various types of volatile or non-volatile storage media. For example, the memory may include a read only memory (ROM) 121 and a random access memory (RAM) 122. In an embodiment of the present disclosure, the memory 120 may be located inside or outside the processor 110, and the memory 120 may be connected to the processor 110 through various known means. As an implementation example, the storage device 150 may be implemented to store raw data, synopsis data, or meta data.

The input interface device 130 is configured to provide data (user query) to the processor 110, and the output interface device 140 is configured to output data (query result) from the processor 110.

The network interface device 160 may transmit or receive a signal to or from other devices through a wired network or a wireless network.

The input interface device 130, the output interface device 140, and the network interface device 160 may be collectively referred to as “interface device.”

The computing device 100 having such a structure is named an apparatus for processing an approximate query and may implement the above methods according to an embodiment of the present disclosure.

In addition, at least some of the methods according to the embodiment of the present disclosure may be implemented as a program or software executed on the computing device 100, and the program or software may be stored in a computer-readable medium.

In addition, at least some of the methods according to the embodiment of the present disclosure may be implemented as hardware that may be electrically connected to the computing device 100.

Embodiments of the present disclosure are not implemented only through the devices and/or methods described above, and may be implemented through a program that realizes functions corresponding to the configuration of the embodiments of the present disclosure or a recording medium on which the program is recorded. Such an implementation can be easily implemented by those skilled in the art to which the present disclosure pertains based on the description of the above-described embodiment.

Although embodiments of the present disclosure have been described in detail hereinabove, the scope of the present disclosure is not limited thereto, but may include several modifications and alterations made by those skilled in the art using a basic concept of the present disclosure as defined in the claims.

What is claimed is:

1. A method of processing an approximate query, comprising:
parsing, by a processing device, a user query when the user query is input through an approximate query language extension interface, the user query being an extended query form including information according to a user requirement;
generating, by the processing device, a basic execution plan based on a result of the parsing, and generating a plurality of executable candidate execution plans based on the basic execution plan;
selecting, by the processing device, an optimal final execution plan reflecting the user requirement from among the plurality of executable candidate execution plans; and
performing, by the processing device, query processing on the user query based on the final execution plan.

2. The method of claim 1, wherein the approximate query language extension interface provides a query grammar extension function that allows a user to select desired accuracy and timeliness.

3. The method of claim 2, wherein the user requirement includes information on an error tolerance range corresponding to the accuracy and information on a query processing allowable time corresponding to the timeliness.

4. The method of claim 1, wherein the approximate query language extension interface provides a query grammar extension function based on a structured query language (SQL) grammar.

5. The method of claim 1, wherein the selecting of the final execution plan includes:
selecting a candidate execution plan that satisfies the user requirement from among the plurality of executable candidate execution plans; and
when there are a plurality of selected candidate execution plans, calculating query processing costs for each candidate execution plan and selecting a candidate execution plan having a minimum query processing cost as the final execution plan.

6. The method of claim 1, wherein, in the generating of the plurality of executable candidate execution plans, a plurality of candidate execution plans are generated using a result inference type model and a synopsis generation type model.

7. The method of claim 6, wherein the generating of the plurality of executable candidate execution plans includes:
inferring a prediction result through a first machine learning model that infers a query prediction result and generating a first candidate execution plan based on the inferred prediction result;
generating a synopsis of the query through a second machine learning model that generates a synopsis, which is synthesized data usable for query processing, from raw data to generate a second candidate execution plan; and
reusing a previously generated synopsis to generate a third candidate execution plan.

8. The method of claim 1, wherein the performing of the query processing includes:
accessing raw data to perform the query processing according to the final execution plan when it is determined that the user query is an exact query based on a parsing result; and
accessing synopsis data, which is synthesized data acquired from the raw data, or prediction result generated by inferring a prediction result of the query to perform the query processing according to the optimal execution plan when it is determined that the user query is an approximate query based on the parsing result.

9. The method of claim 8, wherein the accessing of the synopsis data to perform the query processing according to the optimal execution plan includes:
generating synopsis data based on a machine learning model and performing the query processing using the generated synopsis data; and
performing the query processing using pre-generated synopsis data according to a syntax in a previous query form.

10. The method of claim 8, wherein the accessing the prediction result to perform the query processing according to the optimal execution plan includes:
predicting a query prediction result through a result inference type model; and
performing the query processing using the query prediction result.

11. An apparatus for processing an approximate query, comprising:
an interface device configured to provide an approximate query language extension interface; and
a processor configured to perform query processing according to a user query input through the approximate query language extension interface, the user query being in a form of an extended query including information according to a user requirement,
wherein the processor includes:
a query parser configured to parse the user query;
a query transformer configured to generate a basic execution plan based on the parsing result and generate a plurality of executable candidate execution plans based on the basic execution plan;
a query optimizer configured to select an optimal final execution plan reflecting the user requirement from among the plurality of executable candidate execution plans; and
a query executor configured to perform the query processing on the user query based on the final execution plan.

12. The apparatus of claim 11, wherein the approximate query language extension interface provides a query grammar extension function that allows a user to select desired accuracy and timeliness.

13. The apparatus of claim 12, wherein the user requirement includes information on an error tolerance range corresponding to the accuracy and information on a query processing allowable time corresponding to the timeliness.

14. The apparatus of claim 11, wherein the query optimizer is configured to select a candidate execution plan that satisfies the user requirement from among the plurality of executable candidate execution plans, and calculate query processing costs for each candidate execution plan and select a candidate execution plan having a minimum query processing cost as a final execution plan when the number of selected candidate execution plans is plural.

15. The apparatus of claim 11, wherein the query transformer is configured to generate a plurality of candidate execution plans using a result inference type model and a synopsis generation type model.

16. The apparatus of claim 15, wherein the query transformer is configured to perform:
an operation of inferring a prediction result through a first machine learning model that infers a query prediction result and generating a first candidate execution plan based on the inferred prediction result;
an operation of generating a synopsis of the query through a second machine learning model that generates a synopsis, which is synthesized data usable for query processing, from raw data to generate a second candidate execution plan; and
an operation of reusing a previously generated synopsis to generate a third candidate execution plan.

17. The apparatus of claim 11, wherein the query executor is configured to perform:
an operation of accessing raw data to perform the query processing according to the final execution plan, when it is determined that the user query is an exact query based on the parsing result; and
an operation of accessing synopsis data, which is synthesized data acquired from the raw data, or prediction result generated by inferring a prediction result of the query to perform the query processing according to the optimal execution plan, when it is determined that the user query is an approximate query based on the parsing result.

18. The apparatus of claim 17, wherein, in the case of the operation of accessing the synopsis data to perform the query processing according to the optimal execution plan, the query executor is configured to perform:
an operation of generating synopsis data based on a machine learning model and performing the query processing using the generated synopsis data; and
an operation of performing the query processing using pre-generated synopsis data according to a syntax in a previous query form.

19. The apparatus of claim 11, further comprising:
a metadata storage unit configured to store and manage table and column information of raw data for accessing the raw data, an ML model, and a model instance.

20. The apparatus of claim 17, wherein, in the case of the operation of accessing the prediction result to perform the query processing according to the optimal execution plan, the query executor is configured to perform:
an operation of predicting a query prediction result through a result inference type model; and
an operation of performing the query processing using the query prediction result.
